(19) United States
(12) Patent Application Publication
(10) Pub. No.: US 2009/0289237 A1
(43) Pub. Date: Nov. 26, 2009

(54) Chemiluminescent process and product

(76) Inventor: Earl Cranor, Longmeadow, MA (US)

Correspondence Address: MCHALE & SLAVIN, P.A., 2855 PGA BLVD, PALM BEACH GARDENS, FL, 33410, US

(21) Appl. No.: 12/296,398

(22) PCT Filed: Apr. 7, 2006
(86) PCT No.: PCT/US06/12845

§ 371 Date: Oct. 7, 2008

(51) Int. Cl. C09K 3/00

(52) U.S. Cl. 252/700

(57) ABSTRACT

The present invention teaches a chemiluminescent device along with a process for its production. The invention specifically relates to a chemiluminescent article of manufacture (FIG. 1), which includes a containment device (12) having polymeric outer containment (18, 20), and chemical system of oxalate solution inside frangible vial (14), and activator inside frangible vial (16), both the containment device and chemical system may be selected to be particularly susceptible to environmental degradation subsequent to their use. In a preferred embodiment, the chemiluminescent device is designed for an enhanced shelf life prior to use while remaining capable of losing its physical form and re-entering the environment after use.

### FIELD OF THE INVENTION

This invention relates to chemiluminescent articles of manufacture and chemical systems which are environmentally friendly subsequent to their use; and particularly to a chemiluminescent device designed for enhanced shelf-life prior to use and capable of losing its physical form and re-entering the environment after its usefulness has ended.

### BACKGROUND OF THE INVENTION

Chemiluminescence relates to the production of visible light attributable to a chemical reaction. This chemical reaction has been employed in chemiluminescent light producing devices (e.g. light sticks) of various forms for decades, as they are capable of generating light on demand. In its most basic form the chemiluminescent reaction system is composed of two reactive components in solution, an “oxalate component” comprising an oxalic acid ester and a solvent or mixture of solvents therefore, and a “peroxide component” comprising hydrogen peroxide and a solvent or mixture of solvents. In addition, an efficient fluorescer must be contained in one of the components. An efficient catalyst, necessary for maximizing intensity and lifetime control, may be contained in one of the components.

The oxalate component provides an oxalate ester-solvent combination which permits suitable ester solubility and storage stability. The peroxide component provides a hydrogen peroxide-solvent combination that permits suitable hydrogen peroxide solubility and storage stability.

The solvents of the two components may be different but must be miscible. At least one solvent solubilizes the efficient fluorescer and at least one of the solvents solubilizes the efficient catalyst.

As outlined above, chemical light is produced by mixing an oxalate ester and hydrogen peroxide together in the presence of a catalyst and a fluorescer. Typically, the oxalate ester and fluorescer are dissolved in one solvent to create an oxalate solution. The hydrogen peroxide and catalyst are dissolved in another to form a peroxide solution, also referred to as the “activator”.

A conventional chemical light producing device usually contains an oxalate solution containing bis-(6-carbopentoxy-2,4,5-trichlorophenyl)oxalate (CPPO) which is mixed with a solvent (e.g., dibutyl phthalate or propylene glycol dibenzoate) and a fluorescent dye (e.g., 9,10 bis-(phenylethynyl)anthracene) (BPEA). The activator includes a major portion of hydrogen peroxide, a solvent (e.g., tertiary butanol and dimethyl phthalate) and a catalyst (e.g., salicylate of sodium or other metal).

The lifetime and intensity of the chemiluminescent light emitted can be regulated by the use of certain regulators such as:

1) by the addition of a catalyst which changes the rate of reaction of hydroperoxide. Catalysts which accomplish that objective include those described in M. L. Bender, “Chem. Revs.,” Vol. 60, p. 53 (1960). Also, catalysts which alter the rate of reaction or the rate of chemiluminescence include, but are not limited to those accelerators of U.S. Pat. No. 3,775,366, and decelerators of U.S. Pat. Nos. 3,691,085 and 3,704,231; or

2) by the variation of hydroperoxide; wherein both the type and concentration of hydroperoxide are critical for the purposes of regulation.

Of those catalysts known to be useful, sodium salicylate and various tetraalkylammonium salicylates have been most widely used. Lithium carboxylic acid salts, especially lithium salicylate, lithium 2-chlorobenzoate, and lithium 5-t-butyl salicylate are excellent catalysts for low temperature systems.

The aforementioned commercially practiced chemical systems inside the chemiluminescent devices are not designed for general release into the environment. Although the solvent systems are not environmentally hazardous in small quantities (e.g. that found in conventional hand-held light sticks), if released in large quantities these aforementioned solvents may present environmental and toxicological problems. They are, in fact, considered marine pollutants in many parts of the world (dibutyl phthalate) and possible endocrine disruptors (dimethyl phthalate).

The typical chemical light container is made from a polyolefin (e.g. polyethylene, polypropylene) with the oxalate solution and activator inside, separated until light is needed, for example, by packaging one of the liquids in a sealed glass vial and floating the vial in the second liquid. Light is generated when the end user flexes the plastic outer container, fracturing the glass vial or alternatively by destroying the integrity of a separating member, e.g. a diaphragm or membrane, in any suitable manner thereby allowing the two liquids to mix.

However, these conventional chemical light devices do not disintegrate (lose their physical form), photodegrade, or biodegrade due to the particular polymer utilized in their construction. For instance, polyolefins will exist for hundreds of years in most environments without losing a significant portion of their physical properties. This fact has created problems and concerns in all chemical light devices markets, but especially in the military and commercial fishing markets.

Worldwide, over fifty million devices per year are consumed between the military and commercial fishing markets. This volume of consumption and the manner of the consumption is creating a waste and waste disposal problem. The permanence of the plastic outer container making up the chemical light devices contributes to this waste and waste disposal problem.

Military use of chemical light devices includes providing basic light (illumination), safety marking, covert marking, and as training aids. The uses often involve wide dispersion of multiple chemical light devices over large surface areas of land (many acres). After use, evidence of the military's activities are left behind (the chemical light devices) and will persist for decades or longer. Depending on where the military exercise occurs, this may not be allowed (example: USA or Europe). Military personnel are often required in these areas to attempt to collect all consumed chemical light devices.

Commercial fishermen utilizing long lines to catch swordfish and some species of tuna use chemical light devices as lures or attractants. The long lines are significant in length (often miles long) and deploy thousands of hooks pendent from the long line. A chemical light device is typically attached over each hook. Therefore, thousands of chemical light devices are deployed with each long line. This style of fishing typically occurs at night, with the line deployed in late afternoon or early evening and retrieved the next morning. The commercial fishermen are encouraged to disconnect the chemical light devices and to return them to shore for proper disposal. All will disconnect the chemical light devices, but many do not return them to shore for disposal. Instead, they throw the chemical light devices overboard into the oceans. This has created a significant problem on beaches in many parts of the world, with literally thousands of plastic chemical light devices washing up onto a beach with the tides and currents.

If it were possible to provide both a chemiluminescent product and chemical light system that had a long-shelf life prior to use, yet could re-enter the environment within a reasonable interval after its usefulness was at an end, then a long-felt need in the art would be satisfied.

### DESCRIPTION OF THE PRIOR ART

U.S. Pat. No. 5,346,929 to Guttag discloses a biodegradable plastic including a synthetic polymer, a natural polymer and a polymer attacking agent, and articles made therefrom.

U.S. Pat. No. 5,409,751 to Suzuki et al., is directed toward a degradable container formed from polylactic acid(s) alone or in combination with other hydroxycarboxylic acids.

U.S. Pat. No. 5,759,569 to Hird et al., teaches a biodegradable article manufactured from trans polymers, e.g. trans-1,4-polyisoprene, optionally blended with other biodegradable components, e.g. starch.

U.S. Pat. No. 5,760,118 to Sinclair et al., is directed towards end uses of biodegradable polymers, e.g. their end-use in frequently littered products such as drink containers, construction materials and the like.

U.S. Patent Appl. No. 20030102467 to the present inventor, discloses chemical light devices that do not create waste or waste disposal problems. These novel devices are constructed from a polymeric composition that can disintegrate, photodegrade, and/or biodegrade. Furthermore, the reference sets forth a methodology for selecting/formulating the constituents of a chemiluminescent chemical light system which are biodegradable. However, it has been discovered that some of the biodegradable plastics can negatively affect the oxalate/activator chemical light system after prolonged contact. Impurities or additives in the plastic can leach into the liquid chemical system with time and react with the active ingredients in the chemical light system. In addition, some biodegradable plastics are negatively affected by the chemical light system. For example, the peroxide in the activator can crosslink some biodegradable plastics and change their properties, which can result in embrittlement and reduction in the shelf-life of the device.

While the foregoing prior art devices have advanced the art, nevertheless, there remains a need for a chemiluminescent device having improved stability and longer shelf-life prior to use, wherein the container and possibly the chemiluminescent agents will eventually disintegrate, biodegrade or photodegrade after use.

### SUMMARY OF THE INVENTION

Chemiluminescent articles and methods for their production and use have now been developed which yield chemical light devices having an improved shelf-life prior to use, and capable of disintegrating, photodegrading and/or biodegrading once their utility has ended.

With reference to materials useful as containment devices in the present invention, the following definitions are relied upon.

The term “peroxide component”, as used herein, means a solution of a hydrogen peroxide compound, a hydroperoxide compound, or a peroxide compound in a suitable diluent.

The term “hydrogen peroxide compound” includes hydrogen peroxide and hydrogen peroxide producing compounds.

Hydrogen peroxide is the preferred hydroperoxide and may be employed in the present invention as a solution of hydrogen peroxide in a solvent or as an anhydrous hydrogen peroxide compound such as sodium perborate, sodium peroxide, and the like. Whenever hydrogen peroxide is contemplated to be employed, any suitable compound may be substituted which will produce hydrogen peroxide. The hydrogen peroxide concentration in the peroxide component may range from about 0.2M to about 15M. Preferably, the concentration ranges from about 1M to about 2M.

“Biodegradable” is defined as a material whose component parts are capable of being consumed by microorganisms, such as, bacteria, fungi, or algae, thereby reentering the food chain. The microorganisms break down the polymer chain and consume the material through several methods. The polymers can be either hydrolysable or water soluble. Some common biodegradable plastics are polyesters, polyhydroxybutyrates, and vinyl polymers. As might be expected, the rate at which a particular biodegradable polymer will disappear in a particular time period depends on natural forces (e.g., environment). That is to say, a biodegradable polymer placed in warmer climates (tropics) will be consumed by microorganisms at a different rate than the same biodegradable polymer in colder climates (arctic).

“Reentering the food chain” means that the component can be consumed by either plants or bacteria.

“Disintegrates” is defined as a material which self disintegrates so as to lose its physical (coherent) form within a time-frame (usually decades). Of course this depends on the surrounding milieu. Plastics that disintegrate into small parts have been developed and marketed for years and are often mislabeled “biodegradable”, but are not consumed by microorganisms. This plastic usually comprises an additional component or characteristics which cause it to degrade easily. Starch/polyolefin yard waste bags are an example of this technology. These bags disintegrate (lose coherent form) when they become wet, that is, the starch dissolves in water and frees the bound polyolefin that gave the bag its physical strength and other characteristics. This technology does eliminate the disposal problem of the bag (which could present a hazard to small children and/or animals) by allowing the bag to lose its coherent form. However, a significant component of the bag (the polyolefin) does not actually re-enter the food-chain. Therefore, by the above definition, these bags are not truly biodegradable.

Conventional or “normal” plastics (e.g., polyolefins, polyethylene, polyethylene terephthalate (PET), etc.,) degrade very slowly due to the properties of the plastic utilized in their construction. For example, polyolefins will exist unchanged for hundreds of years.

Photodegradable (e.g., UV degradable) polymers are another example of plastic materials that disintegrate into smaller parts but may not completely re-enter the food chain (partially biodegrades). Examples of this technology are polymers formed by inserting into the polymer chain irregularities that are subject to degradation by UV light. Illustrative of these irregularities are carbonyl groups (ketone carbonyl copolymers or carbon monoxide copolymers) or metal salts. For example, a vinyl ketone comonomer (ketone carbonyl copolymer) inserted into polyethylene chain.

Examples of biodegradable polymers are listed in the following Table 1.

TABLE 1

| Plastic | | Abbre- | |
|---|---|---|---|
| Type | Name | viation | Description |
| Polyesters | Polyglycolic Acid | PGA | Hydrolyzable |
| | | | polyhydroxy acid |
| | Polylactic Acid | PLA | Hydrolyzable |
| | | | polyhydroxy |
| | | | acid; polymers derived |
| | | | from fermenting crops |
| | | | and dairy |
| | | | products; compostable |
| | Polycaprolactone | PCL | Hydrolyzable; low |
| | | | softening and melting |
| | | | points; compostable; |
| | | | long time to degrade |
| Polyhydroxy- | Polyhydroxy- | PHB | Hydrolyzable; produced |
| butyrates | butyrate | | as storage material by |
| | | | microorganisms; |
| | | | possibly degrades in |
| | | | aerobic and anaerobic |
| | | | conditions; stiff; |
| | | | brittle; poor solvent |
| | | | resistance |
| | Polyhydroxyvalerate | PHBV | Hydrolyzable |
| | | | copolymer; processed |
| | | | similar to PHB; |
| | | | contains a substance |
| | | | to increase |
| | | | degradability, melting |
| | | | point, and toughness |
| Vinyl | Polyvinyl Alcohol | PVOH | Water soluble; |
| | | | dissolves during |
| | | | composting |
| | Polyvinyl Acetate | PVAC | Water soluble; |
| | | | predecessor to PVOH |
| | Polyetherketone | PEK | Water soluble; derived |
| | | | from PVOH; possibly |
| | | | degrades in aerobic |
| | | | and anaerobic |
| | | | conditions |

Accordingly, it is an objective of the instant invention to provide a chemiluminescent light producing device having an improved shelf life by segregating each component of the chemical light system from coming into contact with the outer container plastic material that is designed to eventually disintegrate and/or biodegrade after a reasonable period of time, wherein deleterious effects resulting from such contact are precluded.

It is another objective of the instant invention to provide a container for retaining a chemiluminescent chemical light system which is completely biodegradable.

It is a further objective of the instant invention to provide a container wherein the exterior surface has been modified to provide improved aesthetics and wet handling characteristics by providing cross-linking at the surface, e.g., with an oxidizer, thereby reducing the slippery feel of the exterior when the biodegradable container is wet.

It is yet another objective of the instant invention to provide a container for retaining a chemiluminescent chemical light system which disintegrates and substantially biodegrades.

It is still a further objective of the present invention to provide a solvent system for maximization of the effective amount of active ingredients contained therein.

Other objects and advantages of this invention will become apparent from the following description, as set forth, by way of illustration and example, certain embodiments of this invention.

### BRIEF DESCRIPTION OF THE FIGURES

FIG. 1 illustrates one embodiment of the chemical light producing device housing one rupturable vial containing an oxalate solution and another separate rupturable vial containing an activator; and

FIG. 2. illustrates another embodiment of the chemical light producing device housing a vial within a vial, wherein one rupturable vial contains the oxalate solution and the other rupturable vial contains the activator.

### DETAILED DESCRIPTION OF THE INVENTION

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

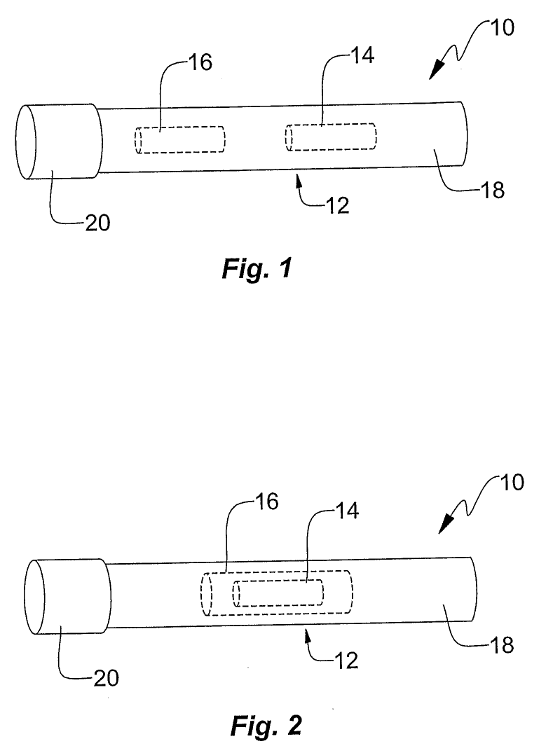

The chemical light outer container 12 of the chemiluminescent light producing device 10, as shown in FIGS. 1 and 2, can be molded from any of the biodegradable, disintegrating and photodegradable polymers as set forth above. These polymers may be molded by any method of molding known in the art (e.g., extruding, injection molding, etc.) The outer container is heat sealed at one end 18 and houses the oxalate and activator components inside. The shelf-life of the light producing device is prolonged by physically separating the active chemical system (oxalate solution and activator) from the polymer of the outer container. This is accomplished by encapsulating all active ingredients in vials or ampules made of any inert material that can be easily ruptured, such as, glass or the like. The remaining end of container is also sealed, shown in the FIGS. with a cap 20.

As shown in FIG. 1 the oxalate solution and activator are separated by packaging the oxalate solution inside a first heat sealed frangible vial 14 and the activator inside a second heat sealed frangible vial 16. Light is generated when the user flexes the plastic outer container, fracturing both the glass vials by any suitable manner that allows the oxalate solution and activator to mix, generating light.

In another embodiment shown in FIG. 2. the oxalate vial 14 is shown floating inside a vial containing activator 16. It is hereby contemplated that the activator vial could be housed inside the oxalate vial without departing from the scope of the invention. This vial-within-a-vial system serves to help ensure that both vials will be broken simultaneously when the user flexes the outer container while preventing negative interactions between the chemical light system and the polymer of the outer container prior to use.

In the embodiments shown in FIGS. 1 and 2, an air space is present in each vial and the biodegradable plastic casing in order to properly heat seal them. This may result in a chemiluminescent device that appears less than half full of the chemical light system of the present invention when the vials are broken, which can result in less light intensity and/or longevity of the resulting chemical light.

To solve this problem, extra oxalate solvent can be filled into the empty air space in the biodegradable plastic casing. However, this extra solvent dilutes the concentration of the active ingredients (i.e., CPPO, peroxide) in the reaction mixture, resulting in less light intensity and/or longevity of the chemical light as compared to a conventional chemical light device (e.g., not biodegradable, disintegrating or photo-disintegrating). Ideally, the chemical light system contained within the container should deliver the same concentration of active ingredients in the reaction mixture as a conventional chemical lighting device.

It has been discovered by the present inventor, that mixtures of various solvents can be blended to improve the solubility of the active ingredients in the entire system that does not compromise the light capacity of the inventive light producing system. Below are several non-limiting examples of these types of blends:

| | Maximum Concentration |
|---|---|
| | of CPPO in System |
| Oxalate Solvent System | (by weight) |
| 100% Acetyl Tributyl Citrate (ATC) | 7% |
| 100% Propylene Glycol Dibenzoate (PGD) | 26% |
| 50%/50% ATC/PGD | 18% |
| 40%/40%/20% ACT/PGD/Glycerol | 34% |
| Tribenzoate | |

By way of comparison, a conventional non-biodegradable chemical light device could contain a glass ampule of an oxalate component floating in an activator solution. The glass ampule would contain 2.8 grams of oxalate component made with 23.5% CPPO, 0.19% BPEA, and 79.31% propylene glycol dibenzoate. The device, in addition to the ampule, contains 7.8 grams of activator component. Thus, the reaction mixture of this typical device, when activated, contains 0.658 grams of CPPO.

A comparable biodegradable device could be made with a glass ampule of oxalate component floating in a glass ampule of activator component floating in solvent in the biodegradable casing. The oxalate ampule could contain 1.9 grams of oxalate made with 34% CPPO, 0.28% BPEA, 26.3% Acetyl Tributyl Citrate, 26.3% Propylene Glycol Tribenzoate, and 12.1% Glycerol Tribenzoate. The activator ampule could contain 2.5 grams of activator while the biodegradable casing contains 3.4 grams of solvent. This device contains 0.646 grams of CPPO, resulting in a light intensity and/or longevity comparable to the non-biodegradable device.

Preferred embodiments of a biodegradable oxalate solvent for use in the present invention may comprise a mixture of propylene glycol dibenzoate/acetyl tributyl citrate (PGD/ATC). The ratio of the PGD/ATC mixture can range from 0/100% to 100/0%. That is, the mixture can contain 100% propylene glycol dibenzoate and no acetyl tributyl citrate, or vice-versa.

A particularly preferred embodiment of a biodegradable oxalate component includes:

| | |
|---|---|
| CPPO (active) | ~23.5% |
| propylene glycol dibenzoate (solvent) | ~80% |
| BPEA (fluorescent dye component) | ~0.2% |

Other supplemental solvents may be added to the oxalate solution in amounts sufficient to further improve the performance of the light intensity and/or longevity of the chemical light reaction by increasing the active ingredient concentrations over solubility limits of any ratio of (PGD/ATC) mixture. Examples of suitable supplemental solvents include, but are not limited to, sucrose benzoate and glycerol tribenzoate.

A particularly preferred embodiment of a biodegradable activator for use in the instant invention includes:

| | |
|---|---|
| hydroperoxide (70% concentration) | ~5% |
| triethyl citrate (solvent) | ~85% |
| t-butanol (solvent) | ~10% |
| sodium salicylate (catalyst) | ~0.0085% |

Typical suitable fluorescent compounds for use in the present invention are those which have spectral emission falling between about 300 and 1200 nanometers and which are at least partially soluble in the diluent employed. Among these are the conjugated polycyclic aromatic compounds having at least 3 fused rings, such as: anthracene, substituted anthracene, benzanthracene, substituted benzanthracene, phenanthrene, substituted phenanthrene, naphthacene, substituted naphthacene, naphthalene, substituted naphthalene, pentacene, substituted pentacene, perylene, substituted perylene, violanthrone, substituted violanthrone, and the like. Typical substituents for all of these are phenyl, alkyl(C₁-C₁₆), chloro, bromo, cyano, alkoxy(C₁-C₁₆), and other like substituents which do not interfere with the light generating reaction contemplated herein.

The preferred fluorescers are 9,10-bis(phenylethynyl) anthracene, 1-methoxy-9,10-bis(phenylethynyl) anthracene, perylene, rubrene, mono and dichloro substituted 9,10-bis(phenylethynyl) anthracene, 5,12-bis(phenylethynyl) tetracene, 9,10-diphenyl anthracene, and 16,17-didecycloxyviolanthrone.

The exterior polymer surface of any of the aforementioned examples of chemical lighting devices may be chemically modified with a surface treatment to alter the wet handling characteristics or topography. It requires immersing or spraying the surface of the heat sealed chemical lighting device of the present invention with a solution that includes an oxidizer. When chemically treating the interior surfaces the oxidant alters the reactivity of said surfaces to reduce interaction with the active components. Alternatively, the interior surface or exterior polymeric surfaces of the chemical producing device may be exposed to electromagnetic radiation in an amount effective to modify the surface characteristics of the inner surface so as to mitigate the deleterious effects of the chemical system or alternatively to modify the outer surfaces to modify the wet handing characteristics.

For example, a desirable biodegradable polymer composition useful in the present invention is PVA. In the context of this application, PVA is understood to comprise a blended polymer, formed from a combination of polyvinyl alcohol and polyvinyl acetate, in proportions effective to control water solubility. One noted drawback to the use of this otherwise highly desirable polymer blend, is a tendency for the polymer surface to be slippery when wet. It has been discovered by the present inventor that subjecting the surface to a mild oxidizing environment is effective to crosslink the polymer surface, thereby improving wet handling characteristics. Illustrative, albeit non-limiting examples of oxidants effective to provide the desired surface modification of the PVA blend include ammonium persulfate, sodium persulfate, potassium persulfate, an ammonium or alkali metal nitrate, an ammonium or alkali metal nitrite, an alkali metal chlorate, an alkali metal bromate, an alkali metal iodate, an alkali metal hypochlorite, hydrogen peroxide or mixtures thereof.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A chemiluminescent light producing device comprising:
a polymeric outer containment device;
at least one pair of frangible ampoules positioned within said containment device, each said pair of ampoules providing a chemiluminescent light producing system including an ampoule containing an oxalate component and an ampoule containing a peroxide component;
wherein said oxalate component and said peroxide component are constructed and arranged to produce visible light when intermixed within said polymeric outer containment device.

2. The chemiluminescent light producing device as set forth in claim 1, wherein said polymeric composition includes at least one biodegradable polymeric material.

3. The chemiluminescent light producing device as set forth in claim 2, wherein said biodegradable polymeric material is a member selected from the group consisting of polyglycolic acid, polylactic acid, polycaprolactone, polyhydroxybutyrate, polyhydroxyvalerate, polyvinyl alcohol, polyvinyl acetate, a water-soluble blend of polyvinyl alcohol and polyvinyl acetate (PVA), and polyetherketone.

4. The chemiluminescent light producing device as set forth in claim 1, wherein said polymeric composition includes at least one polymeric material capable of disintegrating.

5. The chemiluminescent light producing device as set forth in claim 4, wherein said polymeric material capable of disintegrating is a starch/polyolefin combination.

6. The chemiluminescent light producing device as set forth in claim 1, wherein said polymeric composition includes at least one polymeric material capable of photodegrading.

7. The chemiluminescent light producing device as set forth in claim 6, wherein said polymeric material capable of photodegrading is a ketone carbonyl copolymer inserted into a polyethylene chain.

8. The chemiluminescent light producing device as set forth in claim 1, wherein an exterior surface of said polymeric containment device is modified by application of an oxidant or irradiation in an amount effective to crosslink said polymer, thereby improving wet handling characteristics.

9. The chemiluminescent light producing device as set forth in claim 8, wherein said oxidant comprises at least one member selected from the group consisting of ammonium persulfate, sodium persulfate, potassium persulfate, an ammonium or alkali metal nitrate, an ammonium or alkali metal nitrite, an alkali metal chlorate, an alkali metal bromate, an alkali metal iodate, an alkali metal hypochlorite, or hydrogen peroxide.

10. A chemiluminescent light producing device comprising:
an outer containment device formed from a polyvinyl polymer composition;
at least one pair of frangible ampoules positioned within said containment device, each said pair of ampoules providing a chemiluminescent light producing system including an ampoule containing an oxalate component and including a solvent system containing from 0%-100% acetyl tributyl citrate, from 0%-100% propylene glycol dibenzoate, and glyceryl tribenzoate and/or propylene glycol tribenzoate in an amount effective to increase the solubility of oxalates within said solvent system; and an ampoule containing an activator component including triethyl citrate, t-butanol, hydrogen peroxide and sodium salicylate;
wherein upon fracturing of said ampoules, visible light is produced when said oxalate component and activator component are intermixed within said polymeric outer containment device.

11. The chemiluminescent light producing device in accordance with claim 10, wherein said polymeric polyvinyl composition is PVA.

12. The chemiluminescent light producing device in accordance with claim 10, wherein said said exterior surface of said outer containment device is crosslinked;
whereby improved wet-handling characteristics are provided.

13. The chemiluminescent light producing device in accordance with claim 10, wherein said oxalate component includes about 80% propylene glycol dibenzoate, about 24% bis-(6-carbopentoxy-2,4,5-trichlorophenyl)oxalate (CPPO), and about 0.2% 9,10 bis-(phenylethynyl) anthracene (BPEA).

14. The chemiluminescent light producing device in accordance with claim 10, wherein said oxalate component contains 100% propylene glycol dibenzoate, and about 23.5% CPPO.

15. The chemiluminescent light producing device in accordance with claim 10, wherein said oxalate component contains about 40% acetyl tributyl citrate, about 40% propylene glycol dibenzoate, and 20% glycerol tribenzoate;
whereby the concentration of CPPO may be increased to about 34% by weight.

16. The chemiluminescent light producing device in accordance with claim 10, wherein said activator component contains about 85% triethyl citrate, about 10% t-butanol, about 5% of a 70% concentration hydrogen peroxide solution and about 0.0085% sodium salicylate.

17. A chemiluminescent light producing device comprising a biodegradable polymeric composition, said biodegradable polymeric composition forming an outer containment device enclosing at least one inner frangible vial, said outer containment device and said vial containing a chemical system, said outer containment device and said vial each containing one of an oxalate component and a peroxide component of said chemical system, separately, said oxalate component and said peroxide component producing visible light when intermixed in said polymeric outer containment device; and
said biodegradable polymeric composition comprises at least one polymeric material selected from the group consisting of polyglycolic acid, polyactic acid, polycaprolactone, polyhydroxybutyrate, polyhydroxyvalerate, polyvinyl alcohol, polyvinyl acetate, a water-soluble blend of polyvinyl alcohol and polyvinyl acetate (PVA), and polyetherketone;
wherein the exterior surface of said biodegradable polymeric containment device is modified by application of an oxidant or irradiation in an amount effective to crosslink said polymer, thereby improving wet handling characteristics.

18. The chemiluminescent light producing device as set forth in claim 17, wherein an interior surface of said biodegradable polymeric containment device is modified by application of an oxidant or electromagnetic radiation in an amount effective to crosslink said polymer, thereby mitigating deleterious effects of said chemical system upon polymeric containment device.
